(19) United States
(12) Patent Application Publication
(10) Pub. No.: US 2012/0229250 A1
(43) Pub. Date: Sep. 13, 2012

(54) HOST APPARATUS, ACCESSORY APPARATUS, AND AUTHENTICATING AND CONTROLLING METHOD THEREOF

(75) Inventor: Dong-keun LIM, Suwon-si (KR)

(73) Assignee: SAMSUNG ELECTRONICS CO., LTD., Suwon-si (KR)

(21) Appl. No.: 13/233,532

(22) Filed: Sep. 15, 2011

(30) Foreign Application Priority Data
Mar. 11, 2011 (KR) 10-2011-0022066

(51) Int. Cl. G06F 7/04

(52) U.S. Cl. 340/5.8

(57) ABSTRACT

A method for authenticating an accessory apparatus by a host apparatus is provided. The method includes receiving authentication information from the accessory apparatus, comparing the received authentication information and pre-stored authentication information and performing authentication with respect to the accessory apparatus based on a result of the comparing, and, if the authentication is normally performed, performing a function corresponding to the accessory apparatus, and, if the authentication is not normally performed, transmitting corresponding information to an external server.

### CROSS-REFERENCE TO RELATED APPLICATION

This application claims priority from Korean Patent Application No. 10-2011-0022066, filed on Mar. 11, 2011 in the Korean Intellectual Property Office, the disclosure of which is incorporated herein by reference in its entirety.

### BACKGROUND

1. Field

Methods and apparatuses consistent with exemplary embodiments relate to a host apparatus, an accessory apparatus, and an authenticating and controlling method thereof, and more particularly, to a host apparatus and an accessory apparatus which can perform a security function, and an authenticating and controlling method thereof.

2. Description of the Related Art

Current trends indicate that user interest in three-dimensional (3D) films is growing and 3D-related products are increasingly being released. 3D televisions (TVs) and 3D glasses are expensive products, and in particular, it is expected that accessory apparatuses such as 3D glasses will be manufactured by many manufacturers including TV manufacturers as goods with various designs and various functions.

These trends suggest that accessories other than 3D glasses will emerge, if a TV is provided with various application (App)-store functions. Among the accessories, the 3D glasses of the 3D TV will be explained below by way of an example.

As the use of 3D TV has grows, it is expected that a possibility that the expensive 3D glasses are lost or stolen will continuously increase. Besides the 3D glasses, expensive products such as 3D TVs, display apparatuses, iPads, smart phones, or digital media broadcasting (DMB) apparatuses are always exposed to the possibility that they are lost or stolen and are sold via illegal channels. Also, attempts to hack into these products gradually increase.

A related-art method for protecting an accessory apparatus such as 3D glasses belonging to a main product uses a general classifying system for managing customers by managing a code number such as a serial number. Accordingly, it can only be checked whether the sale of a product is lawful based on a product serial number and customer information.

However, in the case that a product is traded unlawfully, there is a need for a method to prevent the product from being used in other areas or other countries. Specifically, since a label on which a serial number is written is easy to break or falsify, there is a need method to prevent a stolen or lost product from coming into the market.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a host apparatus which can improve a security function for an accessory apparatus, an accessory apparatus, and an authenticating and controlling method thereof.

According to an aspect of an exemplary embodiment, there is provided a method for authenticating an accessory apparatus by a host apparatus, the method including receiving authentication information from the accessory apparatus, comparing the received authentication information and pre-stored authentication information and performing authentication with respect to the accessory apparatus; and, if the authentication is normally performed, performing a function corresponding to the accessory apparatus, and, if the authentication is not normally performed, transmitting corresponding information to an external server.

The method may further include, if the authentication is normally performed, transmitting preset setting information corresponding to the accessory apparatus to the accessory apparatus.

The method may further include receiving apparatus information of the accessory apparatus, comparing the received apparatus information and pre-stored lost article information and determining whether the accessory apparatus is a lost article, and, if it is determined that the accessory apparatus is not the lost article, generating authentication information based on the apparatus information, storing the authentication information, and transmitting the authentication information to the accessory apparatus.

The method may further include, if it is determined that the accessory apparatus is the lost article, transmitting the apparatus information ad location information of the accessory apparatus which is determined to be the lost article to the external server.

The apparatus information may include at least one of information on a manufacturer of the accessory apparatus, information on a manufacturing date, information on a purchaser, information on a purchasing date, information on a purchase place, a serial number, and a model name.

The lost article information may be received through a broadcast signal or received through the external server and may be updated at predetermined time intervals or based on a user command.

The method may further include generating a control signal to stop an operation of the accessory apparatus which is determined to be the lost article and transmitting the control signal to the accessory apparatus which is determined to be the lost article.

The method may further include generating information to indicate that the accessory apparatus is the lost article and transmitting the information to the accessory apparatus which is determined to be the lost article.

The external server may be a lost article management server which receives the corresponding information and determines whether the accessory apparatus is a lost article.

According to an aspect of another exemplary embodiment, there is provided a method for controlling an accessory apparatus which performs authentication with a host apparatus, the method including transmitting authentication information to the host apparatus and requesting authentication, and according to a result of the authentication, receiving preset setting information from the host apparatus and setting a function corresponding to the received setting information.

According to an aspect of still another exemplary embodiment, there is provided a host apparatus which performs authentication with an accessory apparatus, the host apparatus including a communication unit which receives authentication information from the accessory apparatus, an authentication unit which compares the received authentication information and pre-stored authentication information and performs authentication with respect to the accessory apparatus, and a controller which, if the authentication is normally performed, performs a function corresponding to the accessory apparatus, and, if the authentication is not normally performed, transmitting corresponding information to an external server.

If the authentication is normally performed, the controller may control setting information corresponding to the accessory apparatus to be transmitted to the accessory apparatus.

The communication unit may receive apparatus information of the accessory apparatus, and the authentication unit may compare the received apparatus information and pre-stored lost article information and determine whether the accessory apparatus is a lost article. If the accessory apparatus is not determined to be the lost article, the controller may generate authentication information based on the apparatus information, store the authentication information, and transmit the authentication information to the accessory apparatus.

If the accessory apparatus is determined to be the lost article, the controller may transmit the apparatus information and location information of the accessory apparatus which is determined to be the lost article.

The apparatus information may include at least one of information on a manufacturer of the accessory apparatus, information on a manufacturing date, information on a purchaser, information on a purchasing date, information on a purchase place, a serial number, and a model name.

The lost article information may be received through a broadcast signal or received through an external server, and may be updated at predetermined time intervals or based on a user command.

The controller may generate a control signal to stop an operation of the accessory apparatus which is determined to be the lost article and transmit the control signal to the accessory apparatus which is determined to be the lost article.

The controller may generate information to indicate that the accessory apparatus is the lost article and transmit the information to the accessory apparatus which is determined to be the lost article.

The external server may be a lost article management server which receives the corresponding information and determines whether the accessory apparatus is a lost article.

According to an aspect of still another exemplary embodiment, there is provided an accessory apparatus which performs authentication with a host apparatus, the accessory apparatus including an authentication request unit which transmits authentication information to the host apparatus and requests authentication, and a controller which, according to a result of the authentication, receives preset setting information from the host apparatus and sets a function corresponding to the received setting information.

Accordingly, user's inconvenience occurring when the accessory apparatus is stolen or lost may be reduced.

Additional aspects and advantages of the exemplary embodiments will be set forth in the detailed description, will be obvious from the detailed description, or may be learned by practicing the exemplary embodiments.

### BRIEF DESCRIPTION OF THE DRAWING

The above and/or other aspects will be more apparent by describing in detail exemplary embodiments, with reference to the accompanying drawings, in which:

FIG. 1 is a view illustrating a system for performing authentication between a host apparatus and an accessory apparatus according to an exemplary embodiment;

FIG. 2A is a block diagram illustrating a host apparatus according to an exemplary embodiment;

FIG. 2B is a block diagram illustrating an accessory apparatus according to an exemplary embodiment;

FIG. 3A is a block diagram illustrating a display apparatus according to an exemplary embodiment;

FIG. 3B is a block diagram illustrating 3D glasses according to an exemplary embodiment;

FIG. 4 is a sequence diagram illustrating a method for performing authentication between a host apparatus and an accessory apparatus according to an exemplary embodiment; and

FIG. 5 is a sequence diagram illustrating a method for operating a host apparatus and an accessory apparatus according to another exemplary embodiment.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail. Further, the term “unit” as used herein means a hardware component and/or a software component that is executed by a hardware component such as a processor or microcontroller.

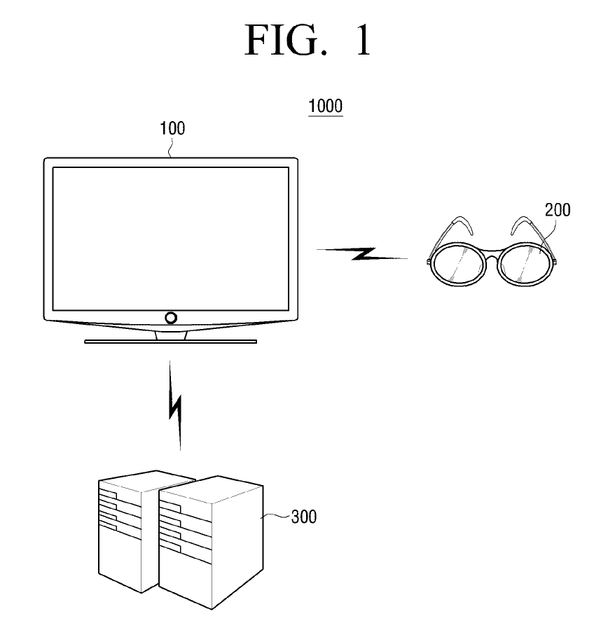

FIG. 1 is a view illustrating a system 1000 for performing authentication between a host apparatus and an accessory apparatus according to an exemplary embodiment. As shown in FIG. 1, a host apparatus 100 may be a display apparatus for displaying a 3D image on a screen and an accessory apparatus 200 may be 3D glasses for viewing the 3D image.

The host apparatus 100 may determine whether the accessory apparatus 200 is a lost article and register the accessory apparatus 200 if it is determined that the accessory apparatus 200 is not a lost article. Herein, a “lost article” is an article or apparatus that has been reported as lost by or stolen from an authorized user, is counterfeit or is otherwise unauthorized for use. The host apparatus 100 may perform authentication with respect to the registered accessory apparatus 200 to be able to perform a function corresponding to the accessory apparatus 200.

On the other hand, if it is determined that the accessory apparatus 200 is a lost article, the host apparatus 100 may transmit information on the accessory apparatus 200 to an external server 300. Also, if the authentication of the accessory apparatus 200 is not normally performed, i.e., authentication of the accessory apparatus is unsuccessful or fails, the host apparatus 100 may transmit corresponding information to the external server 300. The corresponding information may indicate that the authentication of the accessory apparatus 200 was not normally performed.

If it is determined that the accessory apparatus 200 is a lost article or if the authentication is not normally performed, the host apparatus 100 may disable operation of the accessory apparatus 200 or transmit information displaying this state to the accessory apparatus 200.

The accessory apparatus 200 is connected to the host apparatus 100 in a wired or wireless manner and is able to perform a function associated with the host apparatus 100 by being registered in the host apparatus 100 and going through an authenticating process.

Further, the external server 300 may determine whether the accessory apparatus 200 is a lost article based on information received from the host apparatus 100. Also, the external server 300 may transmit lost article information to the host apparatus 100. The external server 300 may be a lost article management server for managing lost article information.

In FIG. 1, the host apparatus 100 and the accessory apparatus 200 are illustrated as a display apparatus and 3D glasses, respectively, but this is merely an example. The host apparatus 100 may be a personal computer, a laptop computer, a mobile phone, an MP3 player, a personal digital assistant (PDA), a digital camera, a plasma display panel (PDP), a navigation system, or a game console, and the accessory apparatus 200 may be a ear phone, a head-set, or a remote controller.

Also, in the above embodiment, one accessory apparatus 200 belongs to the host apparatus 100. However, this is merely an example provided for convenience of explanation and the host apparatus 100 may register a plurality of accessory apparatuses and perform authentication with respect to the accessory apparatuses.

As described above, the host apparatus 100 determines whether the accessory apparatus 200 is a lost article and registers the accessory apparatus 200 if it is determined that the accessory apparatus 200 is not a lost article. The host apparatus 100 normally performs the authentication with respect to only the accessory apparatus 200 that is registered in the host apparatus 100. Accordingly, the host apparatus 100 can prevent the accessory apparatus 200, which is a lost article or is not normally authenticated, from unauthorized us by a third party other than a rightful purchaser.

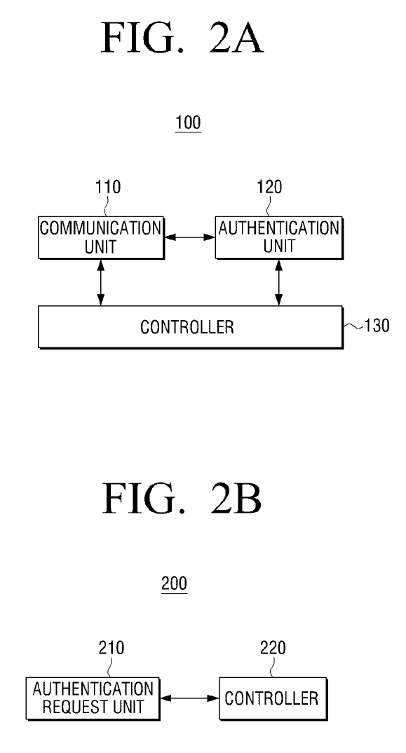

FIG. 2A is a block diagram illustrating a host apparatus according to an exemplary embodiment. Referring to FIG. 1, a host apparatus 100 includes a communication unit 110, an authentication unit 120, and a controller 130.

The communication unit 110 communicates with the accessory apparatus 200 (see FIG. 1) and the external server 300 (see FIG. 1).

More specifically, in order to register the accessory apparatus 200, the communication unit 110 requests apparatus information from the accessory apparatus 200, receives the apparatus information from the accessory apparatus 200, and transmits authentication information generated based on the apparatus information to the accessory apparatus 200. The apparatus information may include at least one of information on a manufacturer of the accessory apparatus 200, information on a manufacturing date, information regarding a purchaser, information on a purchasing date, information on a purchase place, a serial number and a model name.

Also, the communication unit 110 receives setting information from the accessory apparatus 200, and, if authentication is normally performed with respect to the accessory apparatus 200, transmits corresponding setting information to the accessory apparatus 200. The setting information may be diverse option information set in the accessory apparatus 200 by users. In this case, the setting information is received from the accessory apparatus 200 and updated according to the option information finally set by the user.

Further, the communication unit 110 may receive authentication information from the accessory apparatus 200 in order to authenticate the accessory apparatus 200.

The communication unit 110 may receive lost article information from the external server 300 and transmit the apparatus information and location information of the accessory apparatus 200 that is determined to be a lost article to the external server 300. Also, if authentication of the accessory apparatus 200 is not normally performed, the communication unit 110 may transmit corresponding information to the external server 300.

If the accessory apparatus 200 is determined to be a lost article or if the authentication is not normally performed, the communication unit 110 may transmit a control signal to disable operation of the accessory apparatus 200. Also, the communication unit 110 may transmit information indicating that the accessory apparatus 200 is a lost article or information indicating that the authentication is not normally performed to the accessory apparatus 200.

The authentication unit 120 performs authentication with respect to the accessory apparatus 200 using the authentication information. Specifically, the authentication unit 120 compares the authentication information received from the accessory apparatus 200 and pre-stored authentication information to perform the authentication with respect to the accessory apparatus 200.

The controller 130 controls an overall operation of each element of the host apparatus 100. In particular, the controller 130 may control operations of performing registration and authentication with respect to the accessory apparatus 200.

In order to register the accessory apparatus 200, the controller 130 compares the apparatus information received from the accessory apparatus 200 and pre-stored lost article information and determines whether the accessory apparatus 200 is a lost article. The lost article information includes apparatus information on an accessory apparatus that has been reported or accepted as a lost article by a user who lost the accessory apparatus. The lost article information may be received via a broadcast signal or an external server. Also, the controller 130 may update the lost article information at predetermined time intervals or based on a user command.

If it is determined that the accessory apparatus 200 is not a lost article, the controller 130 may generate authentication information based on the received apparatus information. In this case, the controller 130 sets an encryption key based on a built-in key generated at a time that the host apparatus 100 was manufactured (N number of built-in keys) or a key input by the user through an input unit (not shown), and encrypts the apparatus information using an encryption scheme such as a private key encryption scheme (DES) and a public key encryption scheme, thereby generating the authentication information. The private key encryption scheme performs encryption and decryption using the same key, and the public key encryption scheme uses a public key which is open to the public and a private key which is used for only a corresponding apparatus. These encryption schemes are well known in the related art and therefore a detailed description thereof is omitted.

The controller 130 stores the generated authentication information and transmits the authentication information to the accessory apparatus 200 so that the accessory apparatus 200 is registered in the host apparatus 100.

On the other hand, if the accessory apparatus 200 is determined to be a lost article, the controller 130 may transmit the apparatus information and the location information of the accessory apparatus 200 to the external server 300. To achieve this, the controller 130 may generate location information by receiving a global positioning system (GPS) signal sent from a GPS satellite (not shown), and may generate the location information of the accessory apparatus 200 using information containing a trunk number which is a route through which a broadcasting service cable is transmitted.

The controller 130 may generate a control signal to disable operation of the accessory apparatus 200 that is determined to be a lost article or generate information to indicate that the accessory apparatus 200 is a lost article and transmit the information to the accessory apparatus 200. Also, the controller 130 may control a display unit (not shown) provided on the host apparatus 100 to output a message indicating that the accessory apparatus 200 is a lost article.

The controller 130 may control the authentication unit 120 to perform the authentication with respect to the accessory apparatus 200. Specifically, the controller 130 compares the authentication information received from the accessory apparatus 200 and pre-stored authentication information to perform the authentication with respect to the accessory apparatus 200.

As described above, since the host apparatus 100 generates the authentication information using the encryption key selected by the user and transmits the authentication information to the accessory apparatus 200, the accessory apparatus 200 may have different authentication information according the host apparatus 100 in which the accessory apparatus 200 is registered. Therefore, the authentication is not normally performed with respect to the accessory apparatus 200 that is not registered in the host apparatus 100.

For example, it is assumed that only a first accessory apparatus is registered in a first host apparatus and only a second accessory apparatus is registered in a second host apparatus. In this case, since the first host apparatus includes only authentication information on the first accessory apparatus, even if the first host apparatus receives authentication information on the second accessory apparatus, which is generated using a different encryption key, the first host apparatus is not able to normally perform authentication with respect to the second accessory apparatus.

If the authentication is normally performed, the controller 130 performs a function corresponding to the accessory apparatus 200 which is normally authenticated, and control to transmit corresponding setting information to the accessory apparatus 200.

On the other hand, if the authentication is not normally performed, the controller 130 may control to transmit corresponding information to the external server 300. Accordingly, the external server 300 determines whether the accessory apparatus 200 is a lost article based on the received information.

Also, the controller 130 may control the display unit (not shown) to output a message indicating that the accessory apparatus 200 is an unauthorized apparatus and a registration request message. Accordingly, in order to register the accessory apparatus 200, the controller 130 may control to receive apparatus information from the accessory apparatus 200.

In the above embodiment, the host apparatus 100 requests the apparatus information from the accessory apparatus 200 in order to register the accessory apparatus 200. However, this is merely an example. If the accessory apparatus 200 enters an area that is within a predetermined range, the host apparatus 100 may receive the apparatus information from the accessory apparatus 20 without transmitting a separate request.

Also, in the above embodiment, the host apparatus 100 generate the location information. However, this is merely an example. The host apparatus 100 may receive the location information generated through a GPS provided in the accessory apparatus 200.

Also, in the above embodiment, only the information for determining whether the accessory apparatus 200 is a lost article is included in the lost article information. However, this is merely an example. The lost article information may include apparatus information of the host apparatus that has been reported or accepted as a lost article. In this case, the host apparatus 100 determines whether it is a lost article, and, if it is determined that the host apparatus 100 is a lost article, the host apparatus 100 stops its operation.

Also, in the above embodiment, the host apparatus 100 may perform a locking function autonomously. In other words, the host apparatus 100 releases locking and is normally operated only if a password set by a user or set at the time that the host apparatus 100 was manufactured is input through an input unit (not shown) provided on the host apparatus 100.

The host apparatus 100 may encrypt the preset password using a predetermined encryption key and store the password. More specifically, the host apparatus 100 encrypts the password using the encryption key and stores it rather than storing the password as it is. The encryption key may be a built-in key which is generated at the manufacturing time or a key input by the user through the input unit (not shown), and may use an encryption scheme such as a private key encryption scheme (DES) and a public key encryption scheme (RSA).

FIG. 2B is a block diagram illustrating an accessory apparatus according to an exemplary embodiment. As shown in FIG. 2B, an accessory apparatus 200 includes an authentication request unit 210 and a controller 220.

The authentication request unit 210 may transmit apparatus information of the accessory apparatus 200 to the host apparatus 100 (see FIG. 1). Specifically, the authentication request unit 210 may transmit the apparatus information to the host apparatus 100, if the accessory apparatus 200 receives a request for the apparatus information from the host apparatus 100 or if the accessory apparatus 200 enters an area that is within a predetermined range from the host apparatus 100.

The authentication request unit 210 may transmit setting information set in the accessory apparatus 200 to the host apparatus 100. The setting information may be various option information set in the accessory apparatus 200 by the user and the authentication request unit 210 may transmit the setting information every time that the setting information is changed by the user.

Also, the authentication request unit 210 may request authentication from the host apparatus 100. More specifically, the authentication request unit 210 may request authentication of the accessory apparatus 200 by transmitting authentication information received from the host apparatus 100 in which the accessory apparatus 200 is registered to the host apparatus 100. In this case, if the authentication of the accessory apparatus 200 is normally performed, the authentication request unit 210 may receive setting information from the host apparatus 100.

The controller 220 controls an overall operation of the accessory apparatus 200.

In particular, the controller 220 may control each element of the accessory apparatus 200 to perform a function corresponding to the setting information received from the host apparatus 100. More specifically, if preset setting information is received from the host apparatus 100, the controller 220 may perform a relevant operation or may reset a relevant option function according to the setting information.

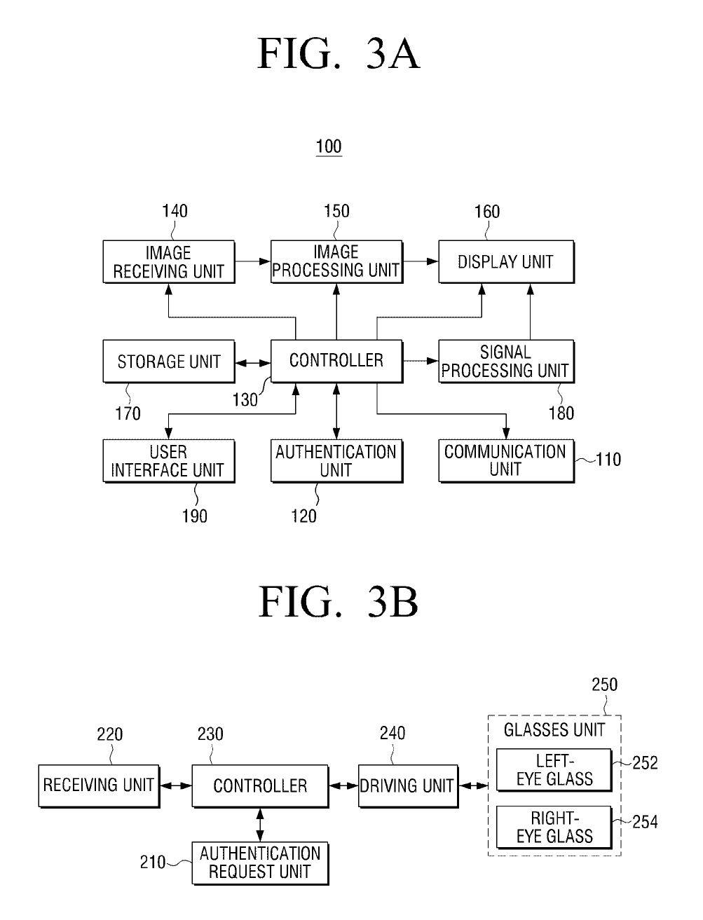

Hereinafter, operations of the host apparatus 100 and the accessory apparatus 200 which are a display apparatus (FIG. 3A) and 3D glasses (FIG. 3B), respectively, will be explained.

FIG. 3A is a block diagram illustrating a display apparatus according to an exemplary embodiment. As shown in FIG. 3A, a display apparatus 100 according to an exemplary embodiment may be a display apparatus for displaying a 3D image on a screen. In explaining FIG. 3A, the same elements as those in FIG. 2A are not described in detail.

The display apparatus 100 of FIG. 3A may display a 3D image or display both a 2D image and a 3D image. The display apparatus 100 may be a 3D TV or any other apparatus that can display a 3D image. For example, the display apparatus 100 may be a 3D monitor or a 3D image projector.

Hereinafter, operations and functions of elements of the display apparatus 100 shown in FIG. 3A will be explained in detail. Referring to FIG. 3A, the display apparatus 100 includes a communication unit 110, an authentication unit 120, a controller 130, an image receiving unit 140, an image processing unit 150, a display unit 160, a storage unit 170, a signal processing unit 180, and a user interface unit 190.

The communication unit 110 communicates with 3D glasses 200 (FIG. 3B) and an external server 300 to perform registration and authentication with respect to the 3D glasses 200. The communication unit 110 may communicate with the accessory apparatus 200 and the external server 300 according to a variety of wired or wireless communication technologies such as wireless fidelity (WI-FI), Internet, a local area network (LAN), Ethernet, TCP/IP, IPX, Fire Wire, IEEE1394, Think, CDMA, TDAM, Bluetooth, high definition multimedia interface (HDMI) CEC, wireless HDMI-CEC, radio frequency (RF), and infrared rays (IR). Also, the communication unit 110 may communicate with the accessory apparatus 200 and the external server 300 using the same communication technology or different communication technologies. In this case, the communication unit 110 may include a plurality of communication modules employing different communication technologies.

The authentication unit 120 performs authentication with respect to the 3D glasses 200 using authentication information received from the 3D glasses 200 and pre-stored authentication information.

The image receiving unit 140 receives 2D or 3D image signals from a broadcasting station or a satellite in a wired or wireless manner and demodulates the 2D or 3D image signals. Also, the image receiving unit 140 may be connected to an external apparatus such as a camera to receive a 3D image from the external apparatus. The image receiving unit 140 may be connected to the external apparatus wirelessly or in a wired manner through an interface such as S-Video, component, composite, D-Sub, DVI, or HDMI. Since a method for processing the 2D image is well known in the related art, a method for processing the 3D image will be mainly explained below.

The 3D image consists of at least one frame. One image frame may include both a left-eye image and a right-eye image or each frame may be a left-eye image or a right-eye image.

The image receiving unit 140 transmits the 2D image or the 3D image to the image processing unit 150.

The image processing unit 150 performs signal processing such as video decoding, format analyzing, and video scaling, and graphic user interface (GUI) adding with respect to the 2D image or the 3D image received from the image processing unit 140.

In particular, the image processing unit 150 generates a left-eye image and a right-eye image corresponding a size of one screen (for example, 1920*1080) using a format of the 2D image or 3D image input from the image receiving unit 140.

The image processing unit 150 time-divides the light-eye image and the right-eye image and alternately transmits the light-eye image and the right-eye image to the display unit 160.

The display unit 160 alternately outputs the left-eye image and the right-eye image output from the image processing unit 150.

The controller 130 controls an overall operation of the display apparatus 100 according to a user command transmitted from the user interface unit 190 or a preset option.

More specifically, the controller 130 controls the image receiving unit 140 to receive the 3D image and controls the image processing unit 150 to divide the 3D image into the left-eye image and the right-eye image, and also, controls to scale or interpolate the left-eye image and the right-eye image such that each of the left-eye image and the right-eye image is displayed on one screen.

Also, the controller 130 may control an operation of performing registration and authentication with respect to the 3D glasses 200 which approach the display apparatus 100.

More specifically, the controller 130 determines whether the 3D glasses 200 are a lost article by comparing apparatus information received from the 3D glasses 200 and pre-stored lost article information. If it is determined that the 3D glasses 200 are not a lost article, the controller 130 encrypts the apparatus information received from the 3D glasses 200 and generates authentication information, and stores and transmits the authentication information so that the 3D glasses 200 are registered.

The controller 130 receives the authentication information from the 3D glasses 200 and compares the authentication information and pre-stored authentication information to perform authentication with respect to the 3D glasses 200.

If the authentication is normally performed, the controller 130 controls the elements of the display apparatus 100 to perform respective functions corresponding to the 3D glasses 200. For example, if the authentication of the 3D glasses 200 is normally performed, the controller 130 may control to display the 3D image.

On the other hand, if it is determined that the 3D glasses 200 are a lost article, the controller 130 transmits the apparatus information of the 3D glasses 200 to the external server 300. In this case, the controller 130 may generate a control signal to disable operation of the 3D glasses 200 and transmits the control signal to the 3D glasses so that the operation of the 3D glasses 200 is disabled.

Also, if the authentication of the 3D glasses 200 is not normally performed, the controller 130 may transmit corresponding information to the external server 300. In this case, the controller 130 may generate and transmit a control signal to disable operation of the 3D glasses 200 or may control the display unit 160 to display a registration request message along with a message indicating that the 3D glasses 200 are unauthorized 3D glasses.

The storage unit 160 is a storage medium configured to store various programs needed for operating the display apparatus 100 and may be a memory or a hard disk drive (HDD). Also, the storage unit 160 may store the lost article information, the apparatus information, and the setting information.

The user interface unit 170 transmits a user command, which is received from an input unit such as a remote controller or an input panel, to the controller 140. In particular, the user interface unit 170 may receive a user command to select an encryption key and receive an encryption key generated by the user.

In the case that the 3D glasses 200 are operated in a shutter glass method, the signal processing unit 180 generates a synchronization (sync) signal to alternately open a left-eye shutter glass and a right-eye shutter glass of the 3D glasses 200 according to a time at which the left-eye image and the right-eye image are displayed, and transmits the sync signal to the 3D glasses 200. The 3D glasses 200 are alternately opened and closed such that the display unit 130 displays the left-eye image at a time when the left-eye glass of the 3D glasses 200 is opened and the right-eye image at a time when the right-eye glass of the 3D glasses 200 is opened. The sync signal may be transmitted in the form of infrared rays.

The signal processing unit 180 signal-processes setting information related to the operation of the registered 3D glasses 200 and transmits the setting information to the 3D glasses 200. The setting information may be diverse option information set in the 3D glasses 200, for example, vision information. Accordingly, the 3D glasses 200 perform a relevant operation or re-set a relevant option function using the setting information. For example, if the 3D glasses 200 receive preset vision information, the 3D glasses 200 re-set a relevant option function automatically using the vision information.

The controller 130 controls an overall operation of the display apparatus 100 according to a user input transmitted from the user interface unit 190.

In particular, the controller 130 controls the image receiving unit 140 to receive the 3D image and controls the image processing unit 150 to divide the 3D image into the left-eye image and the right-eye image, and also, scales or interpolates the left-eye image and the right-eye image such that each of the left-eye image and the right eye image is displayed on one screen.

Also, the controller 130 controls the signal processing unit 180 to generate and transmit a sync signal synchronized with a time at which the left-eye image and the right-eye image are output.

The 3D glasses 200 alternately open the left-eye shutter glass and the right-eye shutter glass according to the sync signal received from the display apparatus 100 so that the user can view the left-eye image and the right-eye image with his/her left-eye and right eye.

The display unit 130 may further include a panel driving unit (not shown), a display panel unit (not shown), a backlight driving unit (not shown), and a backlight emitting unit (not shown), and a detailed description thereof is omitted.

FIG. 3B is a block diagram illustrating 3D glasses according to an exemplary embodiment.

Referring to FIG. 3B, 3D glasses 200 include an authentication request unit 210, a receiving unit 220, a controller 230, a driving unit 240, and a glasses unit 250. The 3D glasses 200 may be of a shutter glass type or a polarization glass type. However, the 3D glasses 200 of the shutter glass type will be explained as an example for convenience of explanation.

The authentication request unit 210 transmits apparatus information of the 3D glasses 200 to the display apparatus 100 (see FIG. 3A), and receives setting information related to the operation of the already registered 3D glasses 200 from the signal processing unit 180 of the registered display apparatus 100. The setting information has been described with reference to FIG. 3A and thus a detailed description is omitted here.

The authentication request unit 210 may request authentication from the display apparatus 100. More specifically, the authentication request unit 210 may request authentication of the 3D glasses 200 from the display apparatus 100 by transmitting authentication information received from the registered display apparatus 100 to the display apparatus 100. In this case, if the authentication of the 3D glasses 200 is normally performed, the authentication request unit 210 may receive setting information from the display apparatus 100.

The receiving unit 220 receives a sync signal regarding a 3D image from the signal processing unit 180 of the display apparatus 100 which is connected to the 3D glasses 200 in a wired or wireless manner. For example, the signal processing unit 180 transmits the sync signal using the infrared rays having directivity and the receiving unit 220 receives the sync signal from the infrared rays

Also, the receiving unit 220 transmits the sync signal received from the signal processing unit 180 to the controller 230.

The controller 230 controls an overall operation of the 3D glasses 200. In particular, the controller 230 generates a control signal based on the sync signal received by the receiving unit 220 and transmits the control signal to the driving unit 240 to control the driving unit 240. In particular, the controller 230 may control the driving unit 240 based on the sync signal such that the driving unit 240 generates a driving signal to drive the glasses unit 250.

The driving unit 240 may drive a shutter of the glasses unit 250 or may rotate glasses of the glasses unit 250.

The glasses unit 250 includes a left-eye shutter glass 252 and a right-eye shutter glass 254. Also, the glasses unit 250 opens and closes each glass or rotates each glass according to the driving signal received from the driving unit 240.

Shutters of the left-eye shutter glass 252 and the right-eye shutter glass 254 may be liquid crystal. In other words, the glasses unit 250 opens and closes the shutters using the liquid crystal of the left-eye shutter glass 252 and the right-eye shutter glass 254.

The 3D glasses 200 may further include a power supply unit (not shown) to supply power to the 3D glasses 200. A power state of the power supply unit (not shown) may be controlled by the controller 230.

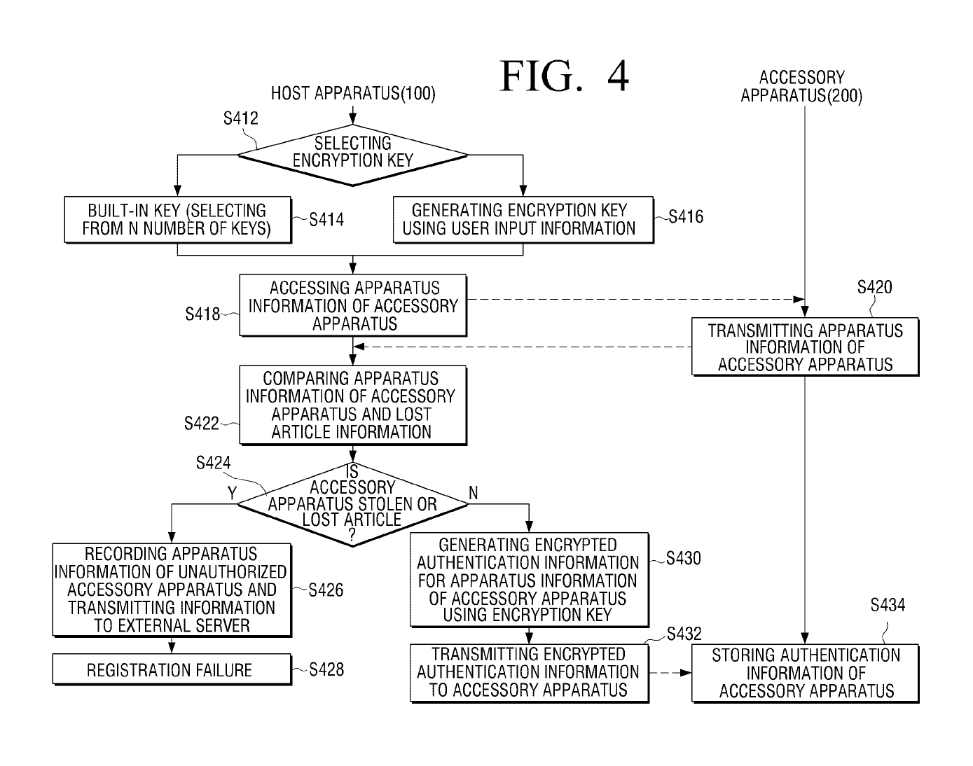

FIG. 4 is a sequence diagram to explain authentication performed between a host apparatus and an accessory apparatus according to an exemplary embodiment.

Referring to FIG. 4, the host apparatus 100 receives an encryption key selection (S412). For example, the host apparatus 100 receives a selection on whether encryption is performed using a pre-stored built-in key or a new encryption key generated.

If performing encryption using the built-in key is selected (S414) or if performing encryption using the new encryption key generated based on input information input by a user is selected (S416), the host apparatus 100 accesses apparatus information of the accessory apparatus 200 (S418).

The accessory apparatus 200 transmits the apparatus information to the host apparatus 100 according to an apparatus information access request from the host apparatus 200 (S420).

The host apparatus 100 compares the apparatus information transmitted from the accessory apparatus 200 and pre-stored lost article information (S422). In this case, the host apparatus 100 may access an external server (not shown) to compare the apparatus information and the lost article information pre-stored in the external server. The operation of comparing may be performed by either the host apparatus 100 or the external server (not shown). The external server 100 may be a lost article management server for storing and managing the lost article information.

It is determined whether the accessory apparatus 200 is a stolen or lost article based on the comparison (S424).

If it is determined that the accessory apparatus 100 is the stolen or lost article (S424: Y), the host apparatus 100 records the apparatus information of the unauthorized accessory apparatus 200 and transmits corresponding information to the external server (S426).

Accordingly, the accessory apparatus 200 fails to be registered (S428) and a message indicating the registration failure is output.

If it is determined that the accessory apparatus 100 is not the stolen or lost article (S424: N), authentication information for the apparatus information of the accessory apparatus 200 is generated using the encryption key (S430).

The authentication information is transmitted to the accessory apparatus 200 (S432).

The accessory apparatus 200 stores the authentication information transmitted from the host apparatus 100 (S434).

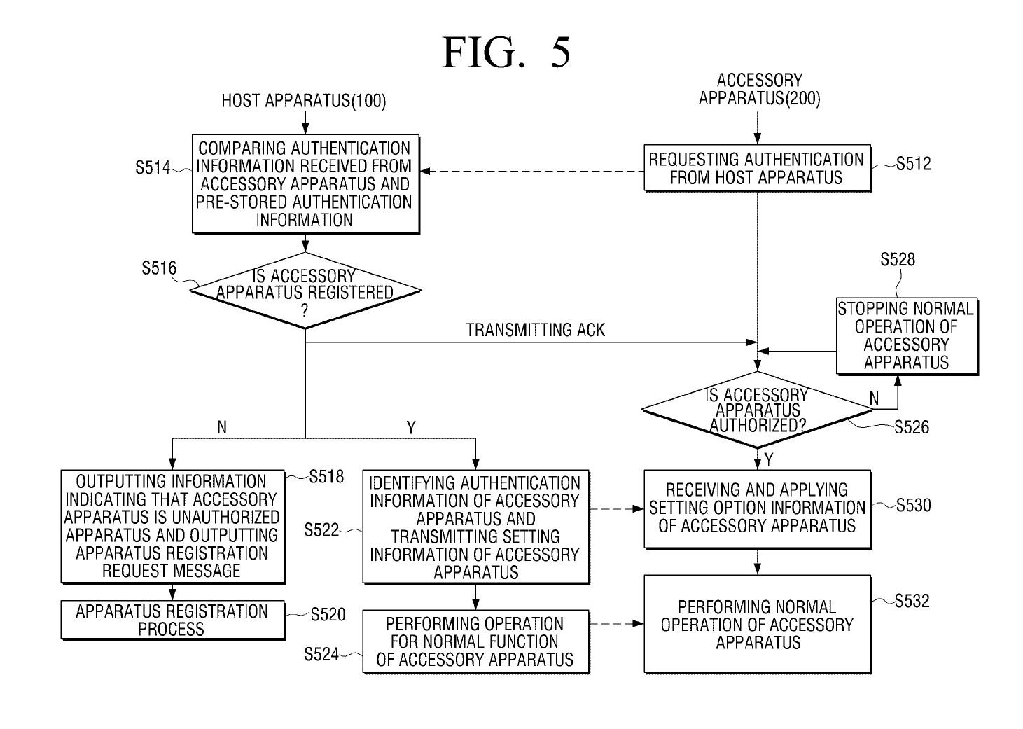

FIG. 5 is a sequence diagram to explain a method for operating a host apparatus and an accessory apparatus according to another exemplary embodiment.

Referring to FIG. 5, if the accessory apparatus 200 requests authentication from the host apparatus 100 (S512), the host apparatus 100 compares authentication information received from the accessory apparatus 100 and pre-stored authentication information (S514).

According to a result of comparing in operation S514, it is determined whether the accessory apparatus 200 is authenticated (S516).

If it is determined that the accessory apparatus 200 is an unauthorized apparatus (S516: N), information indicating that the accessory apparatus 200 is an unauthorized apparatus is output and an apparatus registration request message is output (S518).

In this case, a process of registering an apparatus as shown in FIG. 4 is performed (S520).

If it is determined that the accessory apparatus 200 is an authorized apparatus (S516: N), the authentication information of the accessory apparatus 200 is identified and then an apparatus setting option of the accessory apparatus 200 is transmitted to the accessory apparatus 200 (S522).

The host apparatus 100 performs a normal operation corresponding to the accessory apparatus 200 (S524). For example, if the accessory apparatus 200 is 3D glasses, the host apparatus 100 may output a 3D image.

The accessory apparatus 200 may receive an authentication acknowledgement message as a result of determining whether the accessory apparatus 200 is authenticated in operation S516.

The accessory apparatus 200 determines whether the authentication is normally performed in the host apparatus 100 according the authentication acknowledgement message (S526).

If it is determined that the authentication is normally performed (S526: Y), the accessory apparatus 200 sets a function by applying the setting option transmitted in operation S522. Accordingly, the accessory apparatus 200 performs a normal operation (S532). For example, if the accessory apparatus 200 is 3D glasses of a shutter glass type, the accessory apparatus 200 performs a shuttering operation.

If it is determined that the authentication is abnormally performed (S526: N), the accessory apparatus 200 stops the normal operation (S528).

As described above, if the accessory apparatus 200 belonging to the host apparatus 100 is stolen or lost, the accessory apparatus 200 is prevented from being used by another user. Also, personal data stored in a lost storage medium is prevented from being accessed without authorization. Accordingly, a possibility that the accessory apparatus 200 is stolen or lost decreases and marketing of expensive accessory products having diverse functions is enhanced.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for authenticating an accessory apparatus by a host apparatus, the method comprising, at the host apparatus:
receiving authentication information from the accessory apparatus;
comparing the received authentication information and pre-stored authentication information and performing authentication with respect to the accessory apparatus according to a result of the comparing;
if the authentication is normally performed, performing a function corresponding to the accessory apparatus; and
if the authentication is not normally performed, transmitting corresponding information regarding the authentication not being normally performed to an external server.

2. The method as claimed in claim 1, further comprising, if the authentication is normally performed, transmitting preset setting information corresponding to the accessory apparatus to the accessory apparatus.

3. The method as claimed in claim 1, further comprising:
receiving apparatus information of the accessory apparatus;
comparing the received apparatus information and pre-stored lost article information and determining whether the accessory apparatus is a lost article based on a result of the comparing; and
if it is determined that the accessory apparatus is not the lost article, generating authentication information based on the apparatus information, storing the authentication information, and transmitting the authentication information to the accessory apparatus.

4. The method as claimed in claim 3, further comprising, if it is determined that the accessory apparatus is the lost article, transmitting the apparatus information and location information of the accessory apparatus which is determined to be the lost article to the external server.

5. The method as claimed in claim 3, wherein the apparatus information comprises at least one of information on a manufacturer of the accessory apparatus, information on a manufacturing date, information on a purchaser, information on a purchasing date, information on a purchase place, a serial number, and a model name.

6. The method as claimed in claim 3, wherein the lost article information is received through a broadcast signal or received through the external server and is updated at predetermined time intervals or based on a user command.

7. The method as claimed in claim 3, further comprising generating a control signal to disable operation of the accessory apparatus which is determined to be the lost article and transmitting the control signal to the accessory apparatus which is determined to be the lost article.

8. The method as claimed in claim 3, further comprising generating information indicating that the accessory apparatus is the lost article and transmitting the information to the accessory apparatus which is determined to be the lost article.

9. The method as claimed in claim 1, wherein the external server is a lost article management server which receives the corresponding information and determines whether the accessory apparatus is a lost article.

10. A method for controlling an accessory apparatus which performs authentication with a host apparatus, the method comprising:
transmitting authentication information to the host apparatus and requesting authentication; and
according to a result of the authentication, receiving preset setting information from the host apparatus and setting a function corresponding to the received setting information.

11. A host apparatus which performs authentication with an accessory apparatus, the host apparatus comprising:
a communication unit which receives authentication information from the accessory apparatus;
an authentication unit which compares the received authentication information and pre-stored authentication information and performs authentication with respect to the accessory apparatus based on a result of the comparison; and
a controller which, if the authentication is normally performed, performs a function corresponding to the accessory apparatus, and, if the authentication is not normally performed, transmits corresponding information regarding the authentication not being normally performed to an external server.

12. The host apparatus as claimed in claim 11, wherein, if the authentication is normally performed, the controller controls sets information corresponding to the accessory apparatus to be transmitted to the accessory apparatus.

13. The host apparatus as claimed in claim 11, wherein the communication unit receives apparatus information of the accessory apparatus,
wherein the authentication unit compares the received apparatus information and pre-stored lost article information and determines whether the accessory apparatus is a lost article based on a result of the comparison,
wherein, if the accessory apparatus is not determined to be the lost article, the controller generates authentication information based on the apparatus information, stores the authentication information, and transmits the authentication information to the accessory apparatus.

14. The host apparatus as claimed in claim 13, wherein, if the accessory apparatus is determined to be the lost article, the controller transmits the apparatus information and location information of the accessory apparatus which is determined to be the lost article.

15. The host apparatus as claimed in claim 13, wherein the apparatus information comprises at least one of information on a manufacturer of the accessory apparatus, information on a manufacturing date, information on a purchaser, information on a purchasing date, information on a purchase place, a serial number, and a model name.

16. The host apparatus as claimed in claim 13, wherein the lost article information is received through a broadcast signal or received through an external server, and is updated at predetermined time intervals or based on a user command.

17. The host apparatus as claimed in claim 13, wherein the controller generates a control signal to stop an operation of the accessory apparatus which is determined to be the lost article and transmits the control signal to the accessory apparatus which is determined to be the lost article.

18. The host apparatus as claimed in claim 13, wherein the controller generates information to indicate that the accessory apparatus is the lost article and transmits the information to the accessory apparatus which is determined to be the lost article.

19. The host apparatus as claimed in claim 11, wherein the external server is a lost article management server which receives the corresponding information and determines whether the accessory apparatus is a lost article.

20. An accessory apparatus which performs authentication with a host apparatus, the accessory apparatus comprising:
an authentication request unit which transmits authentication information to the host apparatus and requests authentication by the host; and
a controller which, according to a result of the authentication by the host, receives preset setting information from the host apparatus and sets a function corresponding to the received setting information.
